(19) United States
(12) Patent Application Publication
(10) Pub. No.: US 2019/0345919 A1
(43) Pub. Date: Nov. 14, 2019

(54) PRESS MACHINE

(71) Applicant: Von Arx AG, Sissach (CH)

(72) Inventors: Matthias Ruch, Efringen-Kirchen (DE); Rudolf Kreuzer, Buchs (CH)

(21) Appl. No.: 16/402,182

(22) Filed: May 2, 2019

(30) Foreign Application Priority Data
May 8, 2018 (EP) 18171216.7

(51) Int. Cl. F04B 9/04; B30B 1/32; B30B 15/00; F04B 17/03

(52) U.S. Cl. CPC F04B 9/042; F04B 17/03; B30B 15/0052; B30B 1/32

(57) ABSTRACT

A pressing machine is described comprising a drive with an output shaft for generating a rotational movement. The machine also comprises a transmission which is connected on the input side to the output shaft of the drive. The transmission is connected on the output side with a swash plate. The machine also comprises a pin which is in contact with the swash plate, so that the pin during a rotational movement of the output shaft of the drive, performs a stroke movement.

### FIELD

The present invention relates to a pressing machine, in particular a hand-held pressing machine, as used for the pressing of workpieces, in particular fittings in pipe installation or cable lugs in electrical installation.

### BACKGROUND

Press machines, especially hand-held press machines, are used to press workpieces together, for example workpieces such as fitting and pipe, to permanently connect the workpieces to each other,

Currently, the drive of a hand-held pressing machine consists of an electric motor that drives an eccentric shaft via a gearbox. The gearbox serves to reduce the speed. A nominal speed of the engine, at which the engine has its maximum power, is thus downshifted by means of the transmission to a speed which is adequate for the power consumer.

The output shaft of the electric motor is arranged coaxially with the transmission output shaft and is connected directly or positively with the transmission output shaft. In a press machine with a hydraulic system, a piston pump is then arranged at right angles to the transmission output shaft, an eccentric output shaft shoulder pressing on the piston of the piston pump and moving the piston up and down. As a result of the piston movement, the piston pump delivers a hydraulic fluid into a cylinder space and thus generates a pressing force on the pressing tool attached to the pressing machine for pressing the workpieces.

However, the described drive has the disadvantage that the pressing machine, due to the transmission and the rectangular arrangement of gear and piston pump is overall quite large and unwieldy. Especially in locations with little space, where, for example, pipe connections are to be produced by compression, the use of such a pressing machine is unfavorable and even impossible in some places.

Document DE 101 24 265 A1 describes a friction gear with a gear shaft and conically inclined raceways for a raceway body rotating therein, wherein the raceways are also structured in terms of height over their circumference. The track body performs an axial reciprocating motion during operation. The friction gear of DE 101 24 265 A1 is structurally complicated and very expensive to manufacture due to the height-structured and conically inclined raceways.

It is an object of the present invention to provide a pressing machine which overcomes the above-mentioned disadvantages, is simple to manufacture, and enables reliable and comfortable working even in spatially limited fields of use.

### SUMMARY

The difficulties and drawbacks associated with previous approaches are addressed in the present subject matter as follows.

In one aspect, the present subject matter provides a pressing machine comprising a drive having an output shaft for generating a rotational movement. The pressing machine also comprises a transmission having an input side and an output side. The input side of the transmission connected to the output shaft of the drive. The pressing machine also comprises a swash plate. The swash plate is connected to the output side of the transmission. The pressing machine also comprises a pin in contact with the swash plate such that upon rotational movement of the output shaft of the drive, the pin undergoes a stroke movement.

As will be realized, the subject matter described herein is capable of other and different embodiments and its several details are capable of modifications in various respects, all without departing from the claimed subject matter. Accordingly, the drawings and description are to be regarded as illustrative and not restrictive.

### BRIEF DESCRIPTION OF THE DRAWINGS

Hereinafter, preferred embodiments of the present invention will be illustrated with reference to the accompanying drawings.

FIG. 1 is a schematic representation of an embodiment of a pressing machine;

FIG. 2 is a detail view of the embodiment of the pressing machine of FIG. 1;

FIGS. 3a and 3b show a detail view of the embodiment of the pressing machine of FIG. 1 with a swash plate in a first position (FIG. 3a) and in a second position FIG. 3b), rotated 180° to the first position; and

FIG. 4 is an exploded view of components of the pressing machine of FIG. 1 in a view from the engine to the piston pump (above) and in a view from the piston pump to the engine (below).

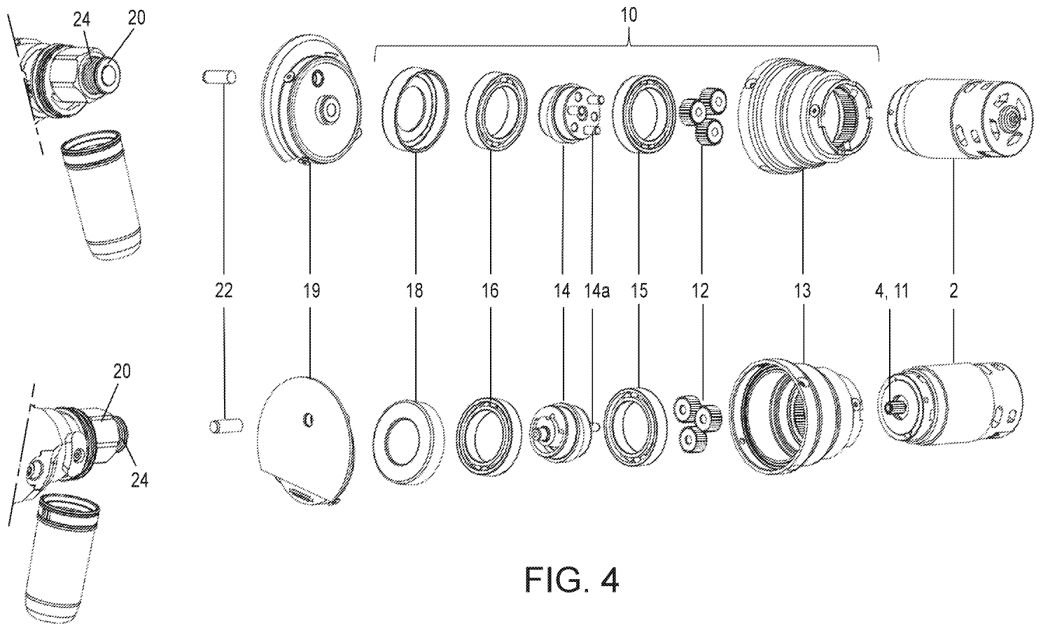

### DETAILED DESCRIPTION OF THE EMBODIMENTS

The above-mentioned problems are addressed according to the subject matter described herein.

In particular, the problems are addressed by a pressing machine, comprising a drive with an output shaft for generating a rotational movement, a transmission, which is connected on the input side to the output shaft of the drive, and the transmission is connected on the output side with a swash plate, and a pin, in contact with the swash plate is, so that the pin executes a stroke movement during a rotational movement of the output shaft of the drive.

A swashplate essentially consists of an inclined surface, whereby, as the swashplate rotates about its center axis, the inclination of the swashplate shifts in an angular range of —β to +β with respect to the axis of rotation. Through the use of a swash plate, the rotational movement of the output shaft of the drive is converted to a lifting movement, i.e., a reciprocating motion. Due to the pin, the lifting movement is in the axial direction of the output shaft. Thus, the components can be arranged one behind the other in the axial direction and enable a slim, thin construction of the pressing machine. Thanks to its slim design, the press machine can also be used in narrow, difficult-to-reach areas. In addition, a swash plate is easy to manufacture and has a low-friction operation, which increases the economy and reliability of the press machine.

Preferably, the transmission is a planetary gear assembly, which has a pinion, planet gears, ring gear and planet carrier. A planetary gear assembly is space-saving and allows a strong reduction of the speed. Thus, with the aid of the planetary gear assembly, the speed of the output shaft, which is optimally in the range of the rated speed of the drive, in particular an electric motor, is provided at a reduced speed, which is suitable for the customer, for the swash plate and in turn for a piston pump.

Preferably, the pinion of the planetary gear assembly is driven by the output shaft of the drive. A direct arrangement of the planetary gear assembly on the output shaft of the drive further allows an axially space-saving design of the pressing machine.

Preferably, the planet carrier has a bearing seat, and a bearing seat plane that is inclined relative to the central axis of the planet carrier. On the bearing seat, swash plate can be arranged. The bearing seat simplifies the installation of the swash plate and stores the swash plate fitting. Due to the inclination of the bearing seat plane arranged thereon, the planar swash plate is also inclined by this angle relative to the central axis of the planet carrier. During a rotational movement of the swash plate, the pin moves due to the inclination of a fixed point on the swash plate in the axial direction along the central axis of the planet carrier. Thereby, a rotational movement of the swash plate in a simple and reliable and space-saving manner in a reciprocating motion, for example, of the pin, is converted in the axial direction.

Preferably, the planetary gear assembly has a first ball bearing for supporting the planet carrier. Due to the ball bearing of the planet carrier, the resulting assembly saves space and is low friction.

Preferably, the planetary gear assembly has a second ball bearing for supporting the swash plate. By the second ball bearing, the swash plate can be moved relative to the planet carrier, i.e., move independently of the movement of the planet carrier.

Preferably, the planet carrier is connected to the swash plate. When the planet gear carrier is connected to the swash plate, the rotational and tumbling motion or only the wobbling motion of the planet gear carrier is transmitted to the swash plate.

Preferably, the swash plate is connected via the second ball bearing with the planet carrier. The connection via the second ball bearing makes it possible that the swash plate does not rotate with the planet carrier but, due to the inclined bearing seat of the second ball bearing on the planet carrier carries out only a wobbling motion,

Preferably, the swash plate does not rotate. This minimizes friction between the pin in contact with the swash plate and the surface of the swash plate.

Preferably, the pin and the swash plate interact with each other via a point contact. In such an arrangement, friction between the pin and the swash plate is further avoided and unwanted heat generation and wear due to friction is reduced or eliminated.

Preferably, the swash plate is integrally formed with the planet carrier. In this case, the swash plate is a part of the planet carrier and the integral component can be produced economically. Furthermore, the installation is facilitated because only one component must be installed or fixed in the press machine. In this case, however, the swash plate rotates with the planet carrier, which increases the friction between the pin and the planet carrier.

Preferably, the pin is pressed against the swashplate to provide permanent contact with the swashplate. The permanent contact is thus independent of the orientation of the pressing machine available. Every movement of the swashplate transfers directly to the pin. Thus, for example, a continuous operation of the piston pump can be ensured even when operating the pressing machine in the direction of gravity.

Preferably, the pin drives a piston of a piston pump or is itself a piston of a hydraulic pump. If the pin drives the piston of a piston pump, the pin can be replaced more easily when worn than the piston itself. If the pin itself is the piston of a hydraulic pump, this eliminates an additional connection of the components and the corresponding space requirement.

The drive is preferably an electric motor, in particular a DC motor. As a result, the pressing machine can also be driven by an accumulator, and can be used mobile. Other drives may include pneumatic, hydraulic or manual drives that provide rotational movement.

Preferably, the pressing machine is a hand-held pressing machine which has a piston pump with hydraulic fluid for generating a pressing force in a hydraulic system. A hand-held pressing machine allows flexible use of the pressing machine. Workpieces, in particular pipes, can already be mounted at their final position and are only connected to one another with the aid of the pressing machine, i.e., pressed. This facilitates assembly in hard to reach areas or complex pipe or workpiece designs.

Hereinafter, preferred embodiments of the present invention will be described in detail with reference to the accompanying drawings.

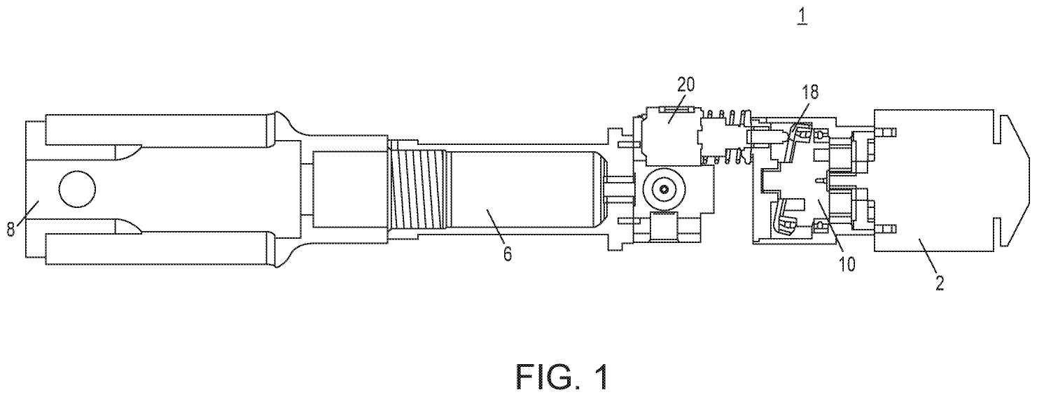

FIG. 1 shows an embodiment of a hand-held pressing machine 1. The pressing machine 1 is constructed in its dimensions and weight so that a user can hold the machine and work with it. The pressing machine 1 is held as a whole elongated to allow working in narrow and hard to reach areas. In particular, when pressing pipelines that are laid in shafts or below work areas, often there is little room for installation, so that a slim shape of the pressing machine 1 is advantageous.

At a first end of the pressing machine 1, an electric motor 2 is mounted as a drive 2, which drives the pressing machine 1. The electric motor 2 is preferably a DC motor and can be operated by a cable connection to the mains or by means of a connected accumulator (not shown). However, other drives 2 that provide rotational movement are also usable. For example, the drive 2 may comprise a pneumatic motor a hydraulic motor or other suitable drives 2. The rotational movement generated by the drive 2 is forwarded via an output shaft 4 to a transmission 10. With the help of the transmission 10, the speed is reduced. The transmission 10 or planetary gear assembly 10 drives a swash plate 18, which converts the rotational movement into a lifting movement in the axial direction A, wherein the lifting movement is used to drive a piston pump 20. Since the lifting movement parallel to the central axis of the pressing machine 1, i.e., parallel to the longitudinal axis of the output shaft 4 takes place, electric motor 2, gear assembly 10, swash plate 18, pin 22 and piston pump 20 can be arranged axially one behind the other, so that the slender shape of the pressing machine 1 is achieved.

The piston pump 20 generates a fluid pressure in a cylinder space by conveying hydraulic fluid. Due to the increasing pressure in the cylinder chamber, a working piston is moved, which drives a pressing tool (not shown), which is attached to the tool holder 8 of the pressing machine 1. The pressing jaws of the tool are closed with increasing pressure in the cylinder chamber and transmit the force to the workpieces to be pressed (not shown) and press them together. In this case, pressing pressures of several hundred bar, preferably 100 to 700 bar can be generated and transmitted.

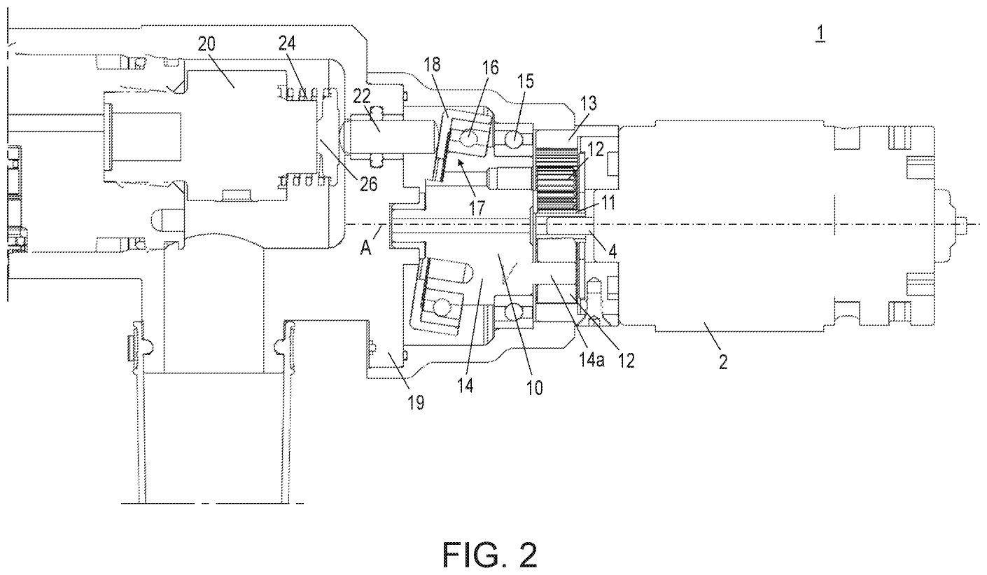

FIG. 2 shows a partial detailed view of an embodiment of he pressing machine 1 in partial section. The transmission 10 is in this embodiment, a planetary gear assembly 10 and is driven directly by the output shaft 4 of the electric motor 2. The transmission 10 is used to reduce the speed while increasing the torque of the output shaft 4. By use of the transmission, smaller, torque-weaker drives 2, in particular electric motors 2 can be used. The reduction is determined by the number of teeth of the pinion 11, the planet wheels or planetary gears 12 and the ring gear 13. The pinion 11 drives the planet gears 12, which rotate in the ring gear 13. The ring gear 13 is fixed. The planet gears 12 can rotate on bolts 14a with respect to the planet carrier 14 and drive it in rotation. Due to the movement of the planetary gears 12, the planet carrier 14 then rotates in the opposite direction to the direction of rotation of the planet wheels 12.

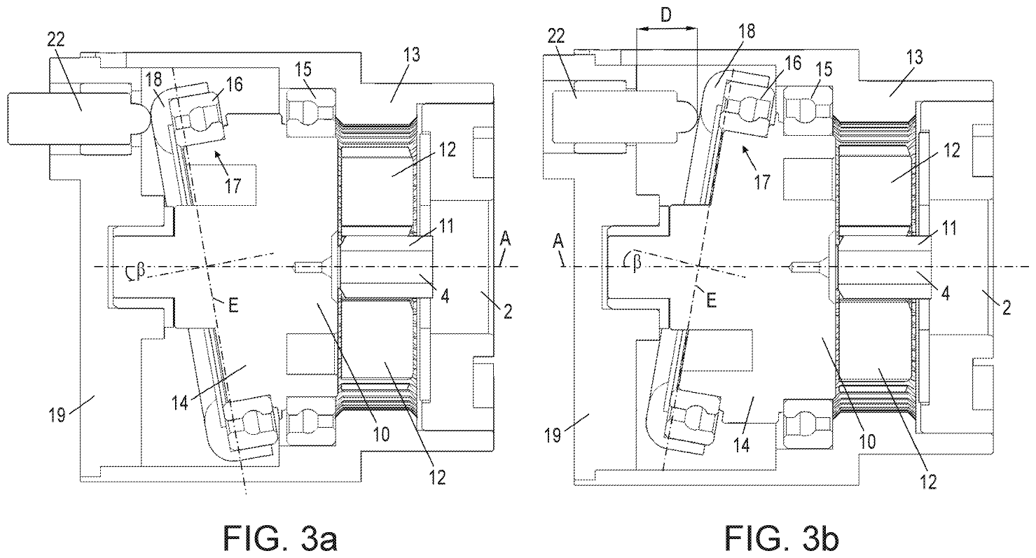

The planet carrier 14 is mounted on its first side by means of a first ball bearing 15 and can rotate relative to the ring gear 13. On the transmission output side, the planet carrier 14 is rotatably mounted with its central axis in an opening of a bearing 19. In addition, the planet carrier 14 on the transmission output side is on an inclined surface E. The inclination of the plane of the surface E by the angle β with respect to the central axis A is preferably 3-45°, more preferably 5-25° and even more preferably 9-12°. The larger the angle 13 is selected, the stronger is the stroke D of the resulting stroke movement in the axial direction, see FIGS. 3a and 3b. The necessary stroke and the effective diameter of the swash plate 18 determine the inclination of the surface E.

In a first embodiment, a swash plate 18 is rotatably mounted on the inclined surface E of the planet carrier 14. The swash plate 18 has a planar, circular shape. At its outer edge, the swash plate 18 may be bent to receive a second ball bearing 16 behind it. The swash plate 18 may be mounted by friction on the planet carrier 14 via the second ball bearing 16, so that it performs a pure wobbling motion, but does not rotate with the planet carrier.

The swash plate 18 is still seated on a bearing seat 17 of the planet carrier 14 and can be installed as appropriate and fast. In further embodiments, the swashplate 18 may be movably or fixedly connected to the planet carrier 14 or formed integrally therewith.

Preferably, the swash plate 18 has no depressions, but is flat on its surface to avoid friction during a movement of the swash plate 18 relative to the pin 22.

Further, the swash plate 18 is in direct contact with a pin 22 which drives a piston pump 20 via its linear oscillating movement. The pin 22 may be in one embodiment, the piston 26 of a piston pump 20 itself. The pin 22 is mounted in a bearing 19 or other support. In one embodiment, the pin 22 is movably inserted through an opening of the bearing 19. The pin 22 is further pressed by means of a spring 24 on the swash plate 18. As shown in FIGS. 2, 3a, and 3b, the pin 22 is preferably rounded off towards the swash plate 18. This results in a particularly low-friction point contact between the pin 22 and the swash plate 18, which moves the pin back and forth.

FIGS. 3a and 3b show two different positions of the swash plate 18 with respect to the pin 22. The swash plate 18 is inclined in each case by the maximum angle amount +/−β. In FIG. 3a, the swash plate 18 is shown inclined so that its contact area with the pin 22 is inclined toward the pin 22. Thereby, the pin 22 is pressed by the swash plate 18 against the spring 24 in the direction of the piston pump 20 and can promote hydraulic oil.

FIG. 3b shows a rotated by 180° position of the swash plate 18 and the planet carrier 14 to the position of FIG. 3a. For this purpose, the planet carrier 14 has been rotated accordingly by 180°. In this position, the swash plate 18 is inclined in its contact area with the pin 22 away from the pin 22, so that the pin 22 is pressed away from the piston pump 20 in the direction of the transmission 10 and the swash plate 18 due to the spring force of the spring 24.

The maximum stroke D of the pin 22 is preferably 3-20 mm, and particularly 5-10 mm. The preferred stroke D is dependent on the stroke of the piston pump 20 and may also be shorter than these values, in particular 1-2.9 mm. The pin 22 is arranged at a certain radial distance from the central axis A. If the pin 22 is arranged closer to the center axis A, then the stroke D decreases at the same angle 13.

In operation, the planetary carrier 14 rotates continuously, so that the pin 22 carries out a continuous oscillating lifting movement or reciprocating movement. By this lifting movement piston pump 20, which is connected to the pin 22, is operated. Per revolution of the planet carrier 14, the pin 22 is pressed by the swash plate 18 once in the direction of the piston pump 20 and by the spring 24 once away from the piston pump 20. The lifting movement causes a conveying of hydraulic fluid in the piston pump 20 for closing the pressing jaws on the pressing machine 1.

Many other benefits will no doubt become apparent from future application and development of this technology.

All patents, applications, standards, and articles noted herein are hereby incorporated by reference in their entirety.

The present subject matter includes all operable combinations of features and aspects described herein. Thus, for example if one feature is described in association with an embodiment and another feature is described in association with another embodiment, it will be understood that the present subject matter includes embodiments having a combination of these features.

As described hereinabove, the present subject matter solves many problems associated with previous strategies, systems and/or devices. However, it will be appreciated that various changes in the details, materials and arrangements of components, which have been herein described and illustrated in order to explain the nature of the present subject matter, may be made by those skilled in the art without departing from the principle and scope of the claimed subject matter, as expressed in the appended claims.

### LIST OF REFERENCE NUMBERS

1 press machine
2 drive, electric motor
4 output shaft
6 working piston
8 tool holder
10 transmission
11 pinion
12 planetary gears
13 ring gear
14 planet carrier
14a bolts
15 first ball bearing
16 second ball bearing
17 bearing seat
18 swashplate
19 bearing or support
20 piston pump
22 pin
24 spring
26 piston
A central axis
D hub
E bearing seat plane
β tilt angle

What is claimed is:

1. A pressing machine comprising:
a drive having an output shaft for generating a rotational movement;
a transmission having an input side and an output side, the input side of the transmission connected to the output shaft of the drive;
a swash plate, the swash plate connected to the output side of the transmission;
a pin in contact with the swash plate such that upon rotational movement of the output shaft of the drive, the pin undergoes a stroke movement.

2. The pressing machine according to claim 1, wherein the transmission is a planetary gear assembly having a pinion, planetary gears, ring gear and planet carrier.

3. The pressing machine according to claim 2, wherein the pinion of the planetary gear from the output shaft of the drive is driven.

4. The pressing machine according to claim 2, wherein the planet carrier has a bearing seat, and a bearing seat plane (E) relative to the central axis (A) of the planet carrier is inclined.

5. The pressing machine according to claim 2, wherein the planetary gear assembly has a first ball bearing for supporting the planet carrier.

6. The pressing machine according to claim 2, wherein the planetary gear assembly has a second ball bearing for supporting the swash plate.

7. The pressing machine according to claim 2, wherein the planet carrier is connected to the swash plate.

8. The pressing machine according to claim 6, wherein the swash plate via the second ball bearing on the planet carrier is mounted.

9. The pressing machine according to clam herein the swash plate does not rotate.

10. The pressing machine according to claim 1, wherein the pin and the swash plate communicate with each other via a point contact.

11. The pressing machine according to claim 2, wherein the swash plate is integral with the planet carrier.

12. The pressing machine according to claim 1, wherein the pin is pressed by means of a spring on the swash plate to provide a permanent contact with the swash plate.

13. The pressing machine according to claim 1, wherein the pin drives a piston of a hydraulic pump or is itself the piston of a hydraulic pump.

14. The pressing machine according to claim 1, wherein the drive is an electric motor.

15. The pressing machine according to claim 14 wherein the electric motor is a DC motor.

16. The pressing machine according to claim 1, wherein the pressing machine is a hand-operated pressing machine having a hydraulic fluid piston pump for generating a pressing force in a hydraulic system.
